(19) United States
(12) Patent Application Publication
(10) Pub. No.: US 2003/0164570 A1
(43) Pub. Date: Sep. 4, 2003

(54) Method for decarburizing ceramic moulded bodies

(76) Inventor: Javier Arrimadas Matias, Graz (AT)

Correspondence Address: SCHIFF HARDIN & WAITE, 6600 SEARS TOWER, 233 S WACKER DR, CHICAGO, IL, 60606-6473, US

(21) Appl. No.: 10/333,141

(22) PCT Filed: May 25, 2001
(86) PCT No.: PCT/DE01/02001

(30) Foreign Application Priority Data
Jul. 18, 2000 (DE) 10034885.8

(51) Int. Cl. C04B 35/638; B32B 18/00

(52) U.S. Cl. 264/82

(57) ABSTRACT

For the complete removal of organic constituents of green members or traditional decarbonized ceramic articles, these are treated with ozone. The treatment, which can be implemented at room temperature, leads to the complete decarbonization of the ceramic article.

Ceramic molded articles currently have numerous applications. In addition to the use as raw material, for example in the automotive sector or in medical technology. [sic] Applications are also numerous for electrical components, whereby the insulating, electrically conductive, piezoelectric, pyroelectric or dielectric properties of various ceramic types are utilized.

In the manufacture of a ceramic molded article, the firing of the ceramic is implemented in two stages. In a first stage, a green ceramic member that, in addition to containing an optimally finely particulate ceramic base material, also usually contains organic binders and, potentially, solvents, is decarbonized at temperatures from 400 through 600 degrees Celsius in an atmosphere that contains at least oxygen. The organic constituents of the binder or the other organic additives in the ceramic mass are thereby burned out. In the second step, which is implemented at the actual sintering temperature, the ceramic is compressed to its final density by sintering. This process occurs at considerably higher temperatures, usually at temperatures far above 1000 degrees Celsius.

The properties of the ceramic are quite significantly dependent on the manufacturing process and, in particular, on the sintering process. The process parameters when sintering determine the ceramic characteristics such as, for example, grain sizes, grain boundaries, density as well as the electrical and other material properties that are dependent thereon. Even a slight deviation from prescribed or, respectively, intended sintering conditions can lead to a ceramic whose properties differ substantially from the desired properties and that may therefore no longer be suited for a desired component under certain circumstances.

Another problem in ceramic molded articles is comprised therein that the complete elimination of the organic constituents of the green member is difficult to implement. In the burn-out, which is also called the decarbonization process, aromatic compounds often arise that are converted into graphite under the conditions of the decarbonization process and, in particular, given inadequate oxygen delivery. This graphite resists further oxidative decomposition and therefore largely remains in the ceramic. In the sintering process following thereupon, the graphite can then trigger reductive processes in the ceramic at the higher sintering temperatures, these leading to modified ceramic properties. These can be so serious that the properties of the ceramic no longer lie in the required range and the ceramic is therefore unusable for the desired purpose.

It is therefore an object of the present invention to specify a method with which a ceramic molded article can be completely decarbonized under mild conditions.

This object is inventively achieved by a method comprising the features of claim 1. Advantageous developments of the invention can be derived from the subclaims.

For decarbonization, the invention proposes that a ceramic molded article be treated with an atmosphere or that the molded article be exposed to an atmosphere that contains at least ozone (O₃). It has been surprisingly shown that an improved decarbonization of the ceramic occurs as a result of such a treatment even under mild conditions and in a time that is comparable to the previous decarbonization process. The inventive method thereby yields a ceramic molded article that comprises a lower carbon content than a ceramic molded article that has been decarbonized in a known, standard method.

Ozone is a triatomic oxygen modification that is already known as a strong oxidation agent. It is nonetheless surprising that a complete binder elimination or, respectively, a complete decarbonization of ceramic molded articles can occur with an ozone-containing atmosphere. The decarbonization can thereby be implemented as an additional method step following the known, standard decarbonization in an oxygen-containing atmosphere. However, it is also possible to completely replace the entire known decarbonization process with the inventive process. It has been shown that the high organic part in green ceramic members is also completely removable by means of the treatment with ozone.

The inventive method can be implemented at normal room temperature (25° C.); an elevation of the temperature for accelerating the process is therefore not required. A ceramic molded article can already be decarbonized at room temperature in a time span comparable to the standard method. Although the ozone molecule is bigger than a corresponding oxygen molecule, ozone exhibits at least the same mobility or, respectively, diffusion capability within the ceramic that is required for thoroughly and completely decarbonizing the ceramic molded article, i.e. into the very inside of the article.

The method can be implemented in an ozone-containing atmosphere, whereby the other atmosphere constituents can correspond to normal atmosphere. For accelerating the process, however, it is possible to employ a pure oxygen atmosphere that is enriched with ozone with the assistance of an ozone generator. Since ozone is unstable in high concentrations due to the high reactivity and a highly concentrated ozone atmosphere tends toward explosive decomposition, an atmosphere is preferred that, in addition to containing the oxygen partly converted into ozone, also contains an inert gas such as, for example, normal atmosphere, which comprises an approximately 80% nitrogen part.

It is also meaningful for the sake of a dependable process management that the temperature at which the method is implemented is not elevated too greatly, whereby a maximum temperature of approximately 50 degrees Celsius seems to be a meaningful upper limit. A temperature lower than room temperature is also suitable, whereby, however, longer reaction times or, respectively, longer decarbonization times are required.

The method can be applied to arbitrary molded articles and is not dependent on the dimensions of the molded article. Preferably, however, the method is applied only given ceramic articles whose desired properties can only be achieved with a complete or far-reaching decarbonization. This applies mainly to electro-ceramic components or, respectively, to ceramic articles that are further-processed into electrical ceramic components. These, however, usually have smaller outside dimensions.

The inventive method is suited for decarbonizing a ceramic member that exclusively comprises a ceramic green member from which binder has potentially been (incompletely) eliminated. However, it is also possible to decarbonized a ceramic multi-layer component with the inventive method, whereby the ceramic molded article comprises ceramic layers and electrode layers in alternation and, thus, further non-ceramic materials. Such multi-layer components can, for example, be selected from multi-layer capacitors, piezo-actuators or ceramic resistor elements. It has been shown that ceramic multi-layer components can also be harmlessly decarbonized with the inventive method. After an inventive decarbonization, the inwardly residing electrodes exhibit only a slightly thicker oxide layer than given a traditional standard decarbonization method.

Preferably, however, the method is applied given multi-layer components that comprise inwardly residing electrode layers of precious metal that are less susceptible to an oxidative attack or, respectively, less reactive based on their very nature. Given electrodes containing silver, it is observed after the implementation of the inventive method that a slight reduction of the silver content occurs, presumably due to the formation of volatile silver compounds. The decrease in the amount of silver, however, is so slight that it is negligible. Given especially sensitive components, this can be compensated by a greater electrode thickness or a higher silver content in the electrode layer or layers or multi-layer components to be treated.

It has been observed as an advantageous side-effect of the inventive method that a ceramic manufactured and sintered in accord therewith comprises a higher density than a comparable ceramic decarbonized with the corresponding standard method. This is attributed thereto that carbon remaining in the ceramic body in the decarbonization impedes the sintering and prevents a maximum density from being achieved. It is presumed that the carbon remaining given incomplete decarbonization reacts with the sintering agent at the sintering temperature and thus impedes the sintering.

The ceramic article with the higher density obtained in the inventive method correspondingly exhibits improved properties connected to the higher density than a corresponding ceramic obtained with standard methods. The reduced porosity of the ceramic leads to a higher dielectric constant ε, so that the inventive ceramic is better suited for all applications wherein dielectric properties and, in particular, electrically insulating properties are required.

In addition to the higher dielectric constant ε, an inventively obtained ceramic also specifically comprises a high electrical breakdown resistance, so that an improved breakdown resistance of electrical ceramic components manufactured therewith is obtained given the same applied voltage. In some ceramic multi-layer components, a potentially slightly increased ESR value (electrical series resistance) can be observed on the inwardly residing metal layers due to the intensified oxidative attack; this, however, still lies within the required specifications since it deviates only slightly from the corresponding values of a ceramic obtained in standard methods. This increase in the SER value has a slight or absolutely no influence on the loss factor of the corresponding ceramic components. The inventive method can therefore be advantageously utilized for the decarbonization of ceramic articles from which electro-ceramic components with demanding specifications or, respectively, with high demands made of the properties of the ceramic are fabricated.

The invention is explained in greater detail below on the basis of exemplary embodiments and the appertaining, five Figures.

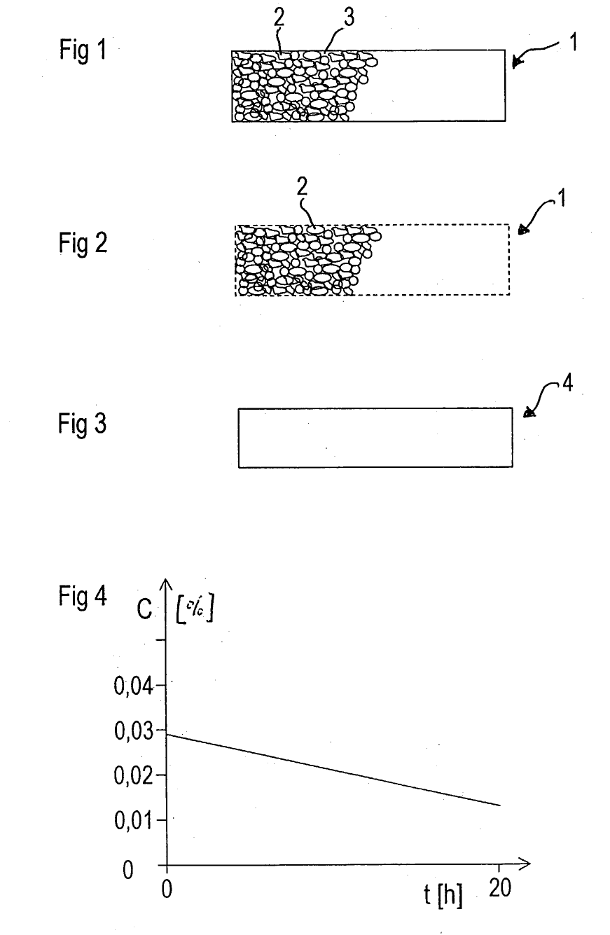

FIGS. 1-3 show a ceramic molded article in a schematic crossection during the two-stage sintering process;

FIG. 4 shows the decrease of the carbon content on the basis of a diagram;

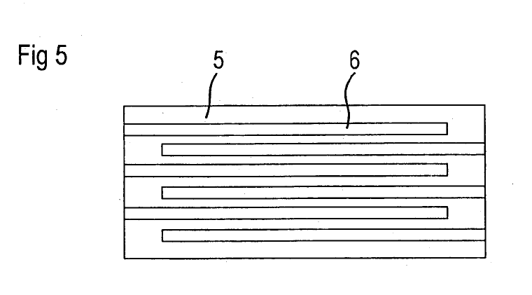

FIG. 5 shows a crossection through a ceramic multi-layer component.

FIG. 1: For manufacturing a high-quality ceramic article, an optimally finely ground ceramic powder 2 is slurried with the assistance of solvent, organic binding agent 3 and, potentially, further additives such as softening agents, wetting agents, anti-adhesion agents and thickening agents, and is converted into a ceramic green member 1 by means of a shaping process. Dependent on the dimension of the ceramic article to be produced, the shaping process can be selected from film casting, film drawing, plastic shaping, casting in molds, milling and the like. The proportion of ceramic particles 2 in the overall green member is thereby as high as possible, so that an optimally high packing density of the ceramic particles in the green member 1 is achieved. FIG. 1 shows portions of this green member in a schematic illustration.

According to a first version, this green member is exposed to an ozone-containing atmosphere. To that end, the green member is placed into a closed container, particularly into a reaction chamber. Via an admission, the chamber is subsequently flooded with an ozone-containing atmosphere, for example with a normal atmosphere that is conducted through an ozone generator, whereby the oxygen part of the normal atmosphere is at least partly converted into ozone. The molded article 1 is subsequently stored in the ozone-filled container at room temperature for approximately 24 hours. The ozone content of the atmosphere within the container that decreases over time can be continuously or discontinuously re-adjusted.

The exact reaction time until the complete decarbonization is dependent on the outside dimensions of the ceramic article to be treated or, respectively, decarbonized, on the density and on the desired degree of decarbonization or, respectively, on the carbon content. For a ceramic component of type 0805, for example, 24 hours at room temperature suffice entirely in order to reduce the carbon content to less than 0.01%.

FIG. 2 shows a partially schematic illustration of the decarbonized ceramic article 1, whereby all organic constituents 3 are removed with the assistance of the ozone. The article 1 comprises a porosity. Gaseous CO₂, H₂O and, potentially, slight amounts of carbon monoxide arise as reaction products. The exhaust air of the inventive method is therefore advantageously treated in an after-burning system wherein incompletely oxidized carbon oxides as well as incompletely consumed ozone are converted into the innocuous end products CO₂ and O₂.

The de-bindered ceramic article is subsequently sintered in a traditional sintering process, for example in an inert gas atmosphere at the desired sintering temperature of, for example, 1300 degrees Celsius. FIG. 3 shows a schematic crossection through the ceramic article 4 that has been obtained, this comprising a maximally obtainable density that close to 100% of the theoretical density and that therefore no longer exhibits any porosity.

FIG. 4 shows the decrease of the carbon content that was identified in a series of trials on the basis of a plurality of measuring points during the process. The approximately linear course of the measured curve in the region under observation shows the high efficiency of the method that leads to a thorough or, respectively, complete elimination of the carbon and, potentially, of other organic constituents in the ceramic green member. The illustrated curve also shows that a nearly complete decarbonization process is possible with the method.

In another version that is not described in greater detail here, a ceramic green member is decarbonized according to a standard method. This comprises a heating of the ceramic green member in an oxygen-containing atmosphere at a temperature from 400 to 600 degrees Celsius. After, for example, 24 through 48 hours decarbonization time at this temperature, a ceramic article is obtained that comprises a residual carbon content of, for example, 0.05 percent by weight. This residual carbon, which is mainly present as graphite, can be nearly completely decomposed with the subsequently implemented, inventive method. A correspondingly shorter treatment duration is needed for this compared to a decarbonization proceeding on the basis of a green member.

FIG. 5 shows a schematic crossection through a ceramic multi-layer component that is constructed of ceramic layers 5 and electrode layers 6 in alternation. For manufacturing this multi-layer component, the corresponding ceramic green films are printed with an electrode paste. The printing can ensue surface-wide or structured, whereby certain regions of the green film are reserved from being printed with electrode paste. The electrode paste is composed, for example, of metal particles comprising silver/palladium that are brought into a printable consistency with a binder as warranted. The green films 5 printed with electrode layers 6 that are stacked on top of one another are subsequently pressed and subjected to the above-described inventive method in this form.

After the inventive decarbonization and the subsequent sintering process, the multi-layer components have their electrical properties tested. The following table indicates the values thereby determined that are compared to the corresponding values of components that were decarbonized and sintered in standard methods.

The table indicates the loss factor TE, the scatter thereof, the ESR value and the scatter thereof.

It can be seen that the electrical characteristics of ceramic components that were decarbonized according to the inventive method approximately correspond to the values obtained in traditional methods and thus lie in the allowed range. This proves that even complex ceramic components like said multi-layer components can be harmlessly and successfully decarbonized with the inventive method. Given the inventive decarbonization of solid ceramic molded articles that do not contain any electrode layers or other alien materials, consistently improved ceramic characteristics are obtained that also lead to electro-ceramic components having improved characteristics. These components are provided with electrodes after the sintering process, so that no interaction with the inventive method arises.

Although the inventive method was only tested on the basis of a few ceramic compositions, it is fundamentally independent of the type of ceramic. The size of the molded article treated with the inventive method is also not a limiting factor. A larger molded article merely lengthens the required reaction time, as is also the case in standard decarbonization processes for large-volume ceramic articles.

1. Method for decarbonizing a ceramic molded article, whereby an unsintered ceramic molded article is exposed to an ozone-containing atmosphere.

2. Method according to claim 1, whereby a ceramic green member is largely freed of binder in a standard process under elevated temperature in an atmosphere containing at least parts of oxygen, whereby the member is subsequently treated with the ozone-containing atmosphere and is completely decarbonized.

3. Method according to claim 1 or 2, whereby the treatment with the ozone-containing atmosphere is implemented for a plurality of hours in a temperature range of 15-50° C.

4. Method according to one of the claims 1-3, whereby the molded article is sintered after the treatment with the ozone-containing atmosphere.

5. Method according to one of the claims 1-4, whereby the molded article is a multi-layer body that comprises ceramic layers and electrode layers in alternation.

6. Method according to one of the claims 1-5, whereby the treatment is implemented with a normal atmosphere wherein at least a part of the oxygen part is converted into ozone.

7. method according to one of the claims 1-5, whereby the treatment is implemented with a pure oxygen atmosphere wherein at least a part of the oxygen is converted into ozone.

8. Method according to one of the claims 1-7, whereby the treatment is implemented in a closed container, and whereby the ozone content in the container is continuously or discontinuously re-adjusted.

9. Employment of the method for decarbonizing green or partially decarbonized ceramic multi-layer bodies constructed stack-like for components with alternating ceramic and electrode layers for increasing the density and, thus, the electrical breakdown resistance of the later components.
